(19) United States
(12) Patent Application Publication
(10) Pub. No.: US 2009/0218786 A1
(43) Pub. Date: Sep. 3, 2009

(54) BICYCLE FRAME

(76) Inventor: Hsiu-Hao Chuang, Pingtung City (TW)

Correspondence Address: LEONG C LEI, PMB # 1008, 1867 YGNACIO VALLEY ROAD, WALNUT CREEK, CA, 94598, US

(21) Appl. No.: 12/040,927

(22) Filed: Mar. 3, 2008

(51) Int. Cl. B62K 19/14

(52) U.S. Cl. 280/281.1

(57) ABSTRACT

The bicycle frame contains a number of frame tubes formed by adhering bamboo strips together in parallel into a bunch and cutting the bunch into having an appropriate cross-sectional shape. Each frame tube has its two ends fitted into two end elements, respectively. The frame tubes are then joined end-to-end together by a number of connectors. The end elements and the connectors are made of a metallic or composite material. The bicycle frame therefore is able to provide environmental friendliness, design flexibility, and to cut down production cost.

### TECHNICAL FIELD OF THE INVENTION

The present invention generally relates to bicycle frames, and more particularly to a bicycle frame formed by frame tubes made of bamboo joined by connectors made of a metallic or composite material.

### DESCRIPTION OF THE PRIOR ART

As shown in FIG. 1, a bicycle frame 1 mainly contains a number of frame tubes 11 joined together by connectors 12. The frame tubes 11 and the connectors 12 are conventionally made of a metallic or composite material. As the cost for metal is continuously increasing, metallic frame tubes have become more costly. On the other hand, frame tubes made of a composite material could be recycled but could only be recycled to something of lower quality. In addition, even though both types of frame tubes could be recycled, the cost for recycling is significant.

Therefore, as shown in FIG. 2, a bicycle frame 2 using bamboo poles as the frame tubes 21 joined by metallic or composite connectors 22 are proposed. The bamboo frame tubes 21 are of course very environmentally friendly. However, bamboo poles always have bamboo joints and are usually not strictly straight, and therefore the frame 2 is less appealing in terms of appearance. Also the choice of bamboo poles could take a significant amount of labor and time. Additionally, bamboo poles are usually cylindrical and the design of the bicycle frame is thereby limited to frame tubes having only cylindrical shape.

### SUMMARY OF THE INVENTION

The primary purpose of the present invention is to provide a novel bicycle frame herein which utilizes bamboo to provide environmental friendliness, design flexibility, and to cut down production cost.

The bicycle frame contains a number of frame tubes formed by adhering bamboo strips together in parallel into a bunch and cutting the bunch into having an appropriate cross-sectional shape. Each frame tube has its two ends fitted into two end elements, respectively. The frame tubes are then joined end-to-end together by a number of connectors. The end elements and the connectors are made of a metallic or composite material.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a conventional bicycle frame made of a metallic or composite material.

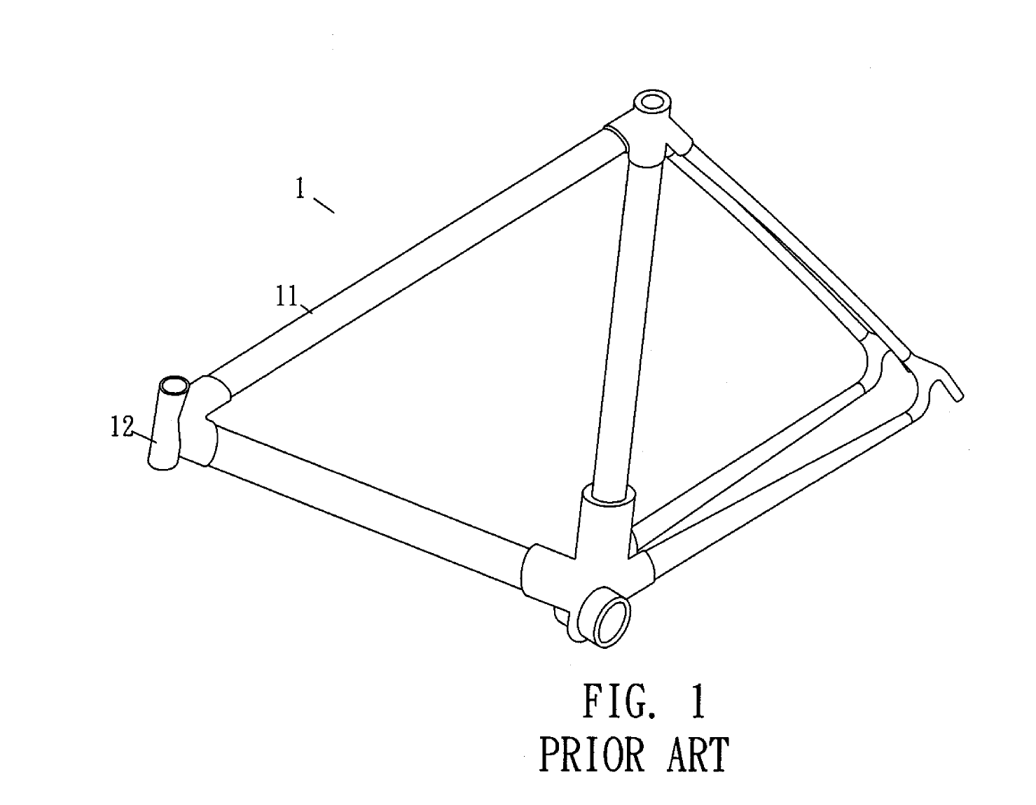

FIG. 2 is a perspective diagram showing a conventional bicycle frame using bamboo poles as frame tubes.

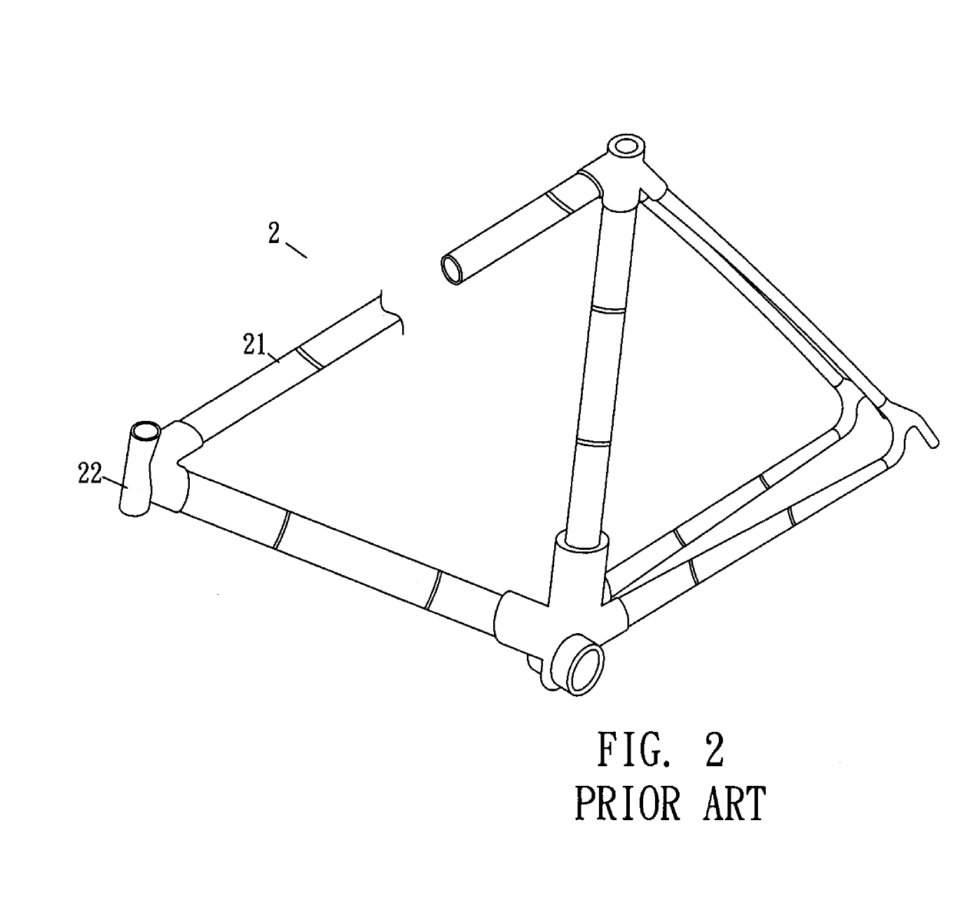

FIG. 3 is a perspective diagram showing a bicycle frame according to a first embodiment of the present invention.

FIG. 4 is a perspective exploded diagram showing the various components of the bicycle frame of FIG. 3.

FIG. 5 is a cross-sectional diagram showing a frame tube according to a first embodiment of the present invention.

FIG. 6 is a cross-sectional diagram showing a frame tube according to a second embodiment of the present invention.

FIG. 7 is a cross-sectional diagram showing a frame tube according to a third embodiment of the present invention.

FIG. 8 is a cross-sectional diagram showing a frame tube according to a fourth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

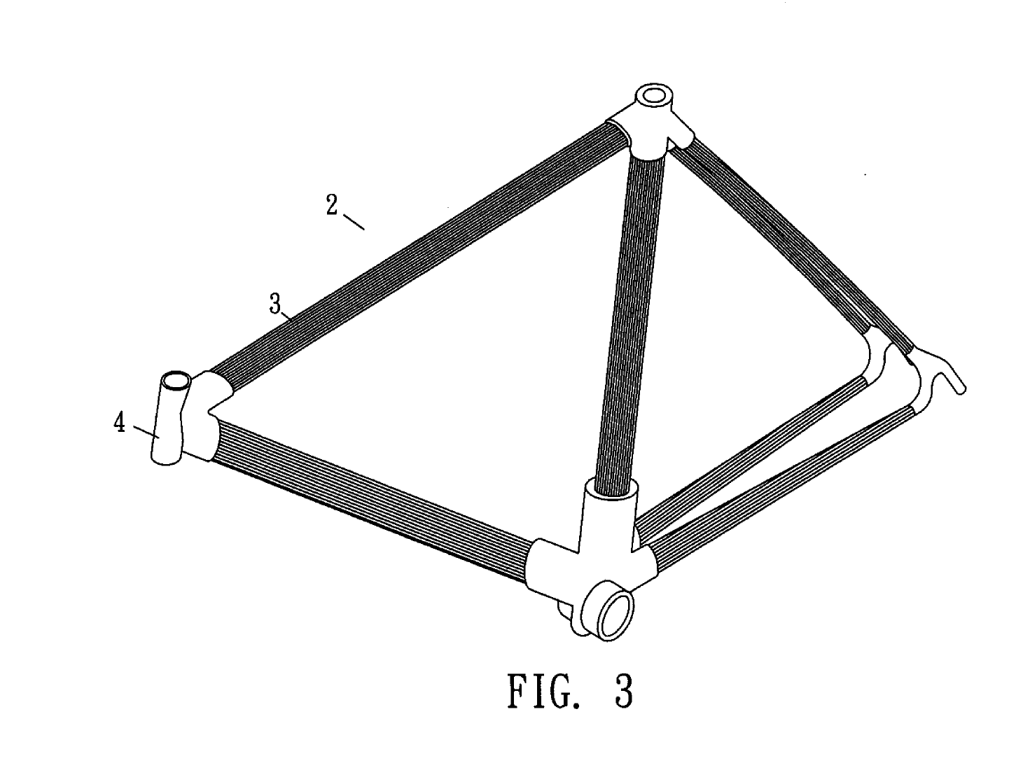

As shown in FIG. 3, a bicycle frame 2 according to an embodiment of the present invention contains a number of frame tubes 3 made of bamboo and a number of connectors 4 made of a metallic or composite material joining the frame tubes 3 end-to-end together.

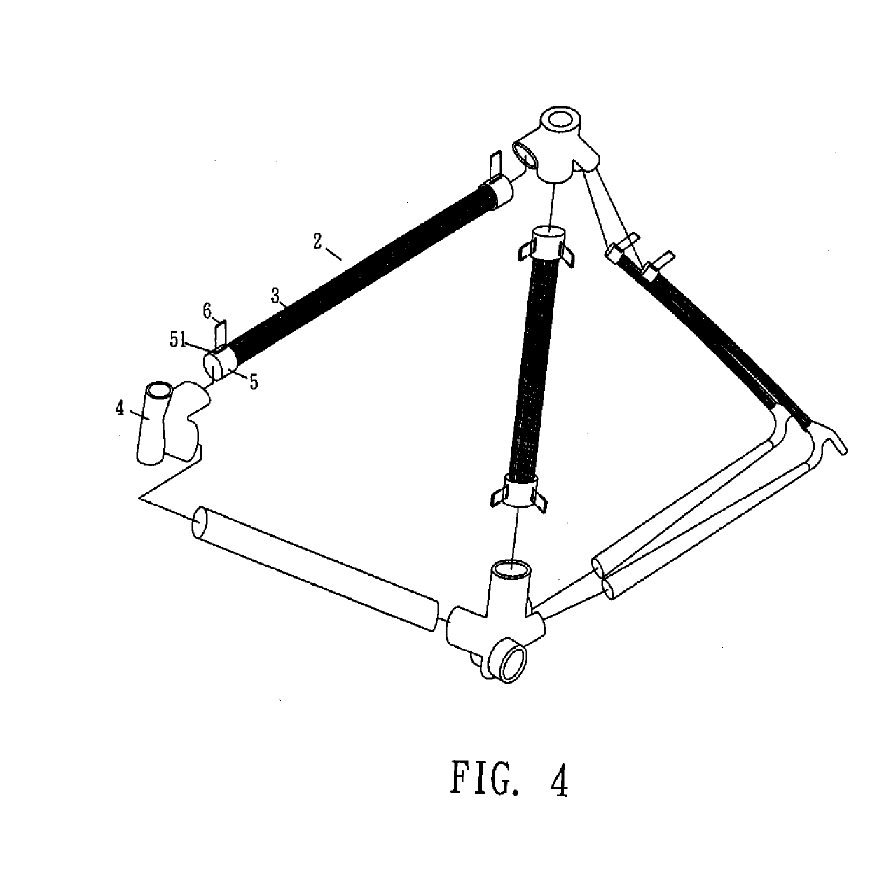

As shown in FIG. 4, each frame tube 3 has its two ends fitted into two end elements 5, respectively. Each end element 5 has a tubular chamber having a compatible shape and dimension with those of the ends of the frame tube 3 so that an end of the frame tube 3 could be threaded into the tubular chamber of the end element 5. Along a circumference of each end element 5, there is at least a slot opening 51. An inverse-U shaped locking element 6 thereby could be driven through the slop opening 51 to fixedly and reliably join the frame tube 3 and the end element 5 together.

The end elements 5 are preferably made of the same material as that of the connectors 4 so as to achieve more reliable connections. In other words, if the connectors 4 are made of a metallic material, the end elements 5 are made of the metallic material as well. If the connectors 4 are made of a composite material, the end elements are also made of the same composite material.

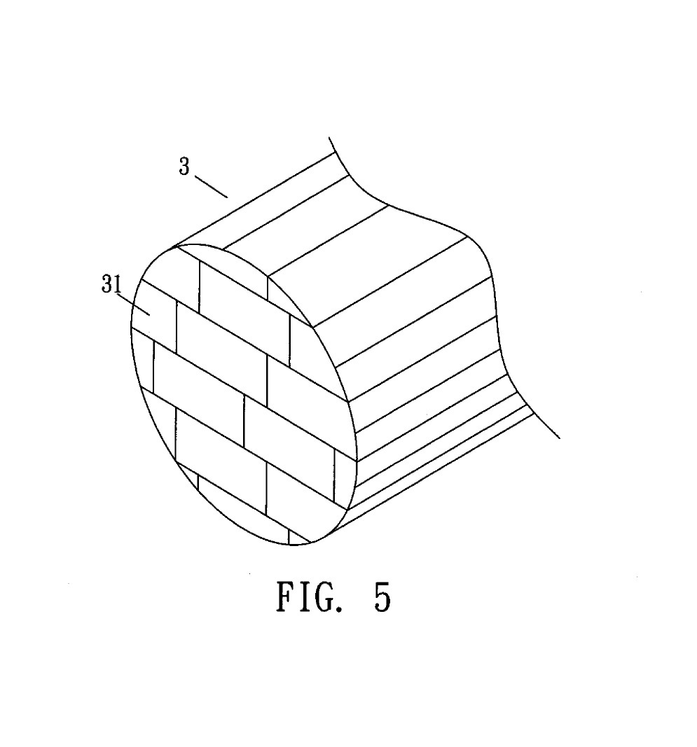

As further shown in FIG. 5, to make the frame tubes 3, bamboo poles are cut into bamboo strips 31. A number of bamboo strips 31 are then adhered together in parallel into a bunch. The bunch of bamboo strips 31 is then cut into a cylinder of an appropriate diameter by turning.

As bamboo is quite light and therefore the bicycle frame 2 could have a compatible or lighter weight compared to a conventional metallic or composite frame. On the other hand, the strength and tenacity of bamboo, even though not quite able to sustain harsh terrain, are more than adequate for ordinary road conditions. Additionally, the supply of bamboo would never be depleted and bamboo could be naturally decomposed so the burden to the environment is minimized. Moreover, the cost of bamboo is much less than a metallic or composite material. Finally, a bunch of bamboo strips 31 could be cut into a tubular form of any appropriate cross-sectional shape so the design of the bicycle frame 2 is more flexible.

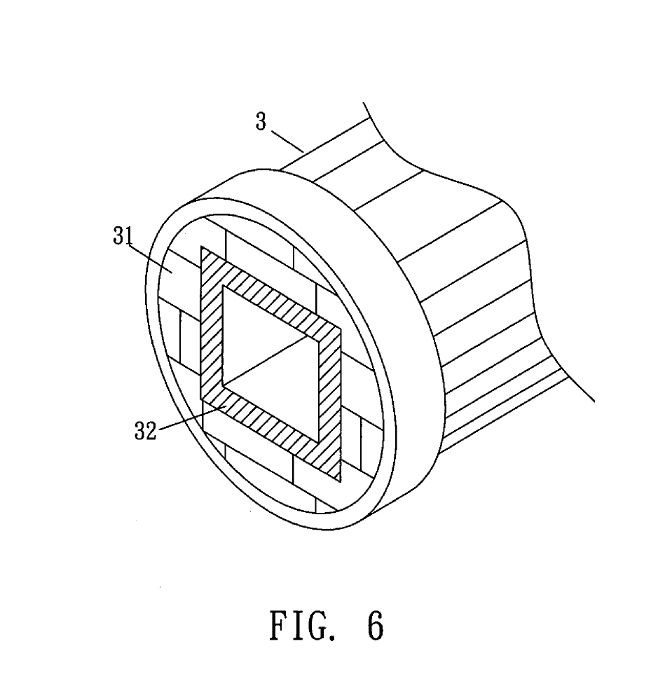

FIG. 6 shows another embodiment of the bamboo frame tube 3. As illustrated, the bamboo strips 31 are adhered together around a tubular core 32. Then, after the bunch of bamboo strips 31 is cut into an appropriate tubular form, the core 32 is removed so as to form a hollow frame tube 3. The bicycle frame 2 formed by these hollow frame tubes 3 therefore could have an even lighter weight without sacrificing much of its strength. The cross-section of the core 32 could have a rectangular shape as used in the present embodiment, a circular shape, or any other appropriate shape.

In addition to bamboo, any other types of wood that is light-weight and has an appropriate strength could also be used to make the frame tubes 3 according to the foregoing description.

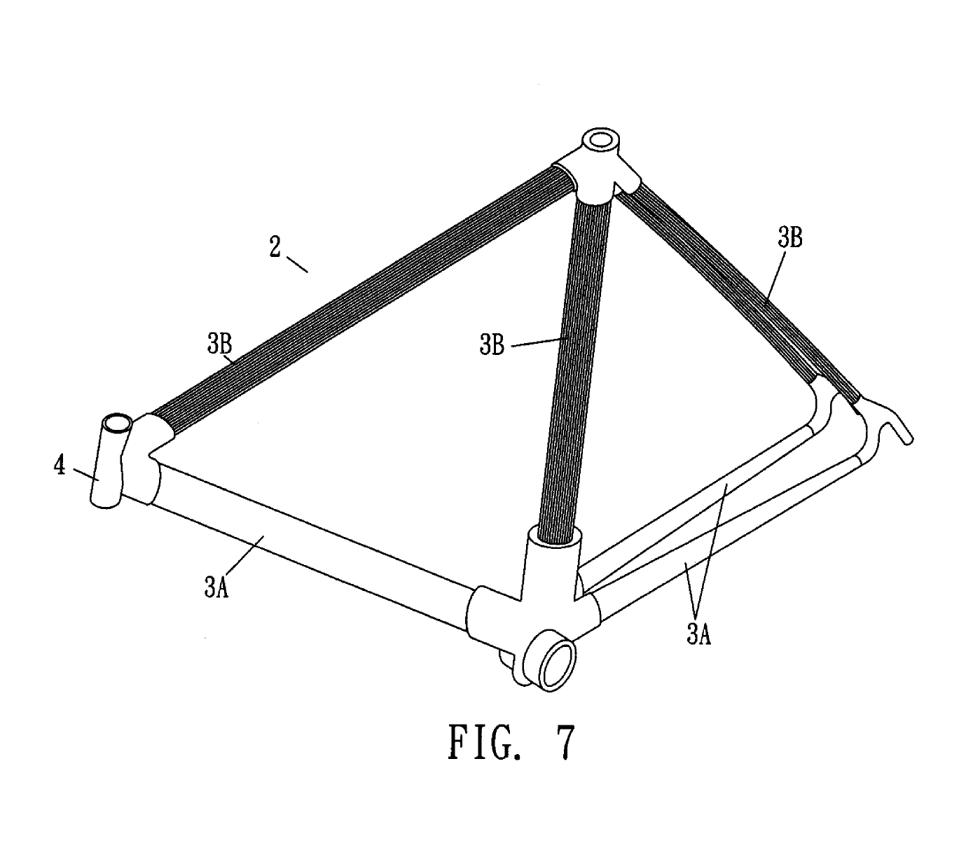

FIG. 7 shows a third embodiment of the present invention which enhances the strength of the bicycle frame 2 to sustain harsh terrains. As illustrated, the bicycle frame 2 has its lower frame tubes 3A (i.e., those closer to the ground and those conventionally referred to as the bottom tube and the chain stay) made of a composite or metallic material and the upper frame tubes 3B (i.e., those conventionally referred to as the top tube, the seat tube, and the seat stay) made of bamboo according to the foregoing description. Please note that an end element 5 is still made of the same material as the connector 4 to which it is connected.

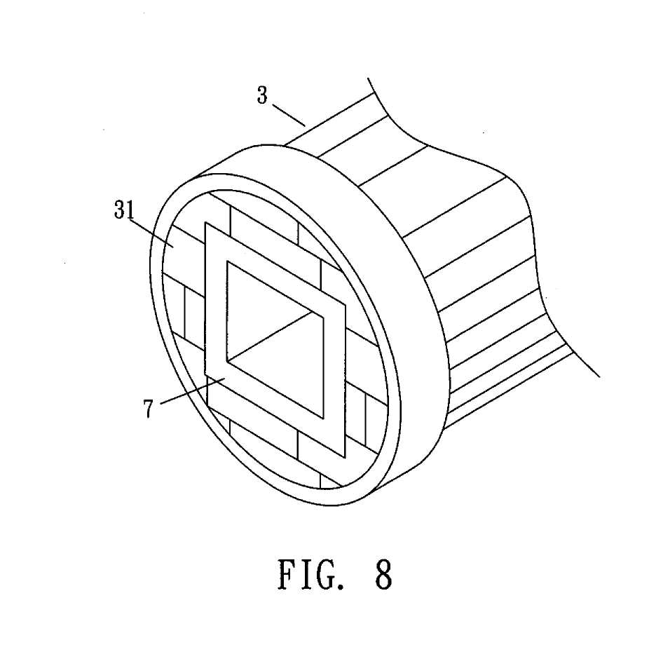

FIG. 8 shows another embodiment of the present invention also for enhancing the strength of the bicycle frame 2 to sustain harsh terrains. As illustrated, the bamboo strips 31 are adhered together around a tubular core 7, as described earlier in making hollow frame tubes 3. However, after the bunch of bamboo strips 31 is cut into an appropriate tubular form, the core 7, made of a composite or metallic material is not removed. The bicycle frame 2 formed by these frame tubes 3 therefore could have an enhanced strength. The cross-section of the core 7 could have a rectangular shape as used in the present embodiment, a circular shape, or any other appropriate shape.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A bicycle frame comprising:
a plurality of frame tubes, at least one of said frame tubes formed of a plurality of strips made of a woody material adhered together in parallel into a bunch and cut into having an appropriate cross-sectional shape, each frame tube further having its two ends fitted into two end elements, respectively; and
a plurality of connectors made of one of a metallic material and a composite material joining said frame tubes end-to-end together into said bicycle frame;
wherein each end element is made of the same material as that of a connector to which said end element is connected.

2. The bicycle frame according to claim 1, wherein said woody material is bamboo.

3. The bicycle frame according to claim 1, wherein at least one of said frame tubes is hollow.

4. The bicycle frame according to claim 1, wherein one of said frame tubes functioning as the chain stay of said bicycle frame is made of one of a metallic material and a composite material.

5. The bicycle frame according to claim 1, wherein one of said frame tubes functioning as the bottom tube of said bicycle frame is made of one of a metallic material and a composite material.

6. The bicycle frame according to claim 1, wherein at least one of said frame tubes has a tubular core made of one of a metallic material and a composite material wrapped around by said strips.
